(19) United States
(12) Patent Application Publication
(10) Pub. No.: US 2026/0195595 A1
(43) Pub. Date: Jul. 9, 2026

(54) SCORE INTERPOLATION DIFFUSION MODELS

(71) Applicant: DeepMind Technologies Limited, London (GB)

(72) Inventors: Sander Etienne Lea Dieleman, London (GB); Laurent Patrice Marc Sartran, London (GB); Nikolay Savinov, London (GB); Iaroslav Ganin, London (GB); Pierre Richemond, London (GB); Arnaud Doucet, Oxford (GB); Christopher James Dyer, London (GB); Conor Michael Durkan, New York, NY (US); Rémi Leblond, Cachan (FR); Will S. Grathwohl, New York, NY (US); Robin Strudel, Paris (FR); Curtis Glenn-Macway Hawthorne, Sunnyvale, CA (US)

(21) Appl. No.: 19/132,537

(22) PCT Filed: Nov. 23, 2023
(86) PCT No.: PCT/EP2023/082883

§ 371 Date: May 23, 2025

Related U.S. Application Data
(60) Provisional application No. 63/427,784, filed on Nov. 23, 2022.

(51) Int. Cl. G06N 3/084; G06F 40/40

(52) U.S. Cl. CPC G06N 3/084; G06F 40/40

(57) ABSTRACT

Methods, systems, and apparatus, including computer programs encoded on computer storage media, for generating an output sequence of discrete tokens using a diffusion model. In one aspect, a method includes initializing the output sequence by assigning a respective embedding to each of the plurality of output positions; repeatedly performing the following at each of multiple reverse diffusion steps: a current continuous representation of the output sequence; processing a diffusion model input that comprises the current continuous representation using the diffusion model to generate a diffusion model output; processing the respective initial scores using a softmax function to generate, for each of the plurality of output positions, a probability distribution over the plurality of embeddings in the vocabulary of embeddings; and updating the continuous representation of the output sequence using the probability distributions and the vocabulary of embeddings.

### CROSS-REFERENCE TO RELATED APPLICATION

This application claims priority to U.S. Provisional Application No. 63/427,784, filed on Nov. 23, 2022. The disclosure of the prior application is considered part of and is incorporated by reference in the disclosure of this application.

### BACKGROUND

This specification relates to using neural networks to perform machine learning tasks on discrete data.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In some cases, discrete data refers to data that may take on or have a finite or countably infinite number of values; continuous data may take on any value within a continuous range of possible values. In a broader sense, continuous data refers to data that may take on any value within a specified range, constrained only by the precision of the numerical format used by a computer system. Discrete data have additional constraints that further limit the possible values that the data may take on within the specified range beyond those possible values in the numerical format used by the computer system.

### SUMMARY

This specification describes a system implemented as computer programs on one or more computers in one or more locations that generates an output sequence of discrete tokens using a diffusion model which performs a reverse diffusion process on continuous embeddings.

In some cases, the generation process is unconditional where the output sequence may be generated by the diffusion model from random noise. In other cases, the generation process is conditional and the output sequence is generated conditioned on a conditioning input, e.g., where an output text, computer program code, symbol, or signal sequence generated by the diffusion model is a completion or expansion of an input text, computer program code, symbol, or signal sequence.

According to a first aspect, there is provided a computer-implemented method for generating an output sequence that comprises a respective discrete token selected from a vocabulary of discrete tokens at each of a plurality of output positions, wherein the method comprises: initializing a continuous representation of the output sequence by assigning a respective embedding to each of one or more of the plurality of output positions, each embedding being selected from a vocabulary of embeddings that comprises a respective embedding corresponding to each discrete token in the vocabulary of discrete tokens; repeatedly performing the following at each of multiple reverse diffusion steps: obtaining a current continuous representation of the output sequence; processing a diffusion model input that comprises the current continuous representation using the diffusion model to generate a diffusion model output, wherein the diffusion model output comprises, for each of the plurality of output positions, a respective initial score for each of the plurality of embeddings in the vocabulary of embeddings; processing the respective initial scores using a softmax function to generate, for each of the plurality of output positions, a probability distribution over the plurality of embeddings in the vocabulary of embeddings that includes a respective probability score for each embedding in the vocabulary of embeddings; and updating the current continuous representation of the output sequence using the probability distributions and the vocabulary of embeddings.

Updating the current continuous representation of the output sequence using the probability distributions and the vocabulary of embeddings may comprise: determining, using the respective probability scores and the vocabulary of embeddings, a score function estimate for the output sequence; and updating the current continuous representation of the output sequence by applying an ordinary differential equation (ODE) solver to the score function estimate.

Updating the current continuous representation of the output sequence of the output sequence by applying the ODE solver to the score function estimate may comprise: using the ODE solver to evaluate the score function estimate to determine a respective updated embedding for at least one of a subset of the output positions in the current continuous representation of the output sequence.

Determining the score function estimate may comprise: using the probability distributions and the vocabulary of embeddings to determine a respective interpolated embedding for each of the subset of the plurality of output positions.

Determining the score function estimate for the output sequence may comprise, at each of the plurality of output positions: computing a difference between the respective interpolated embedding for the output position and a current embedding for the output position in the current continuous representation of the output sequence.

Processing the diffusion model input that comprises the current continuous representation using the diffusion model may comprise: applying normalization across the current embeddings in the current continuous representation.

The method may further comprise receiving a conditioning input sequence that comprises one or more conditioning tokens, and wherein initializing the output sequence may comprise: selecting, from the vocabulary of embeddings, embeddings at one or more given output positions of the output positions based on the one or more conditioning tokens; and generating initial embeddings at remaining output positions of plurality of output positions with at least some measure of randomness.

The method may further comprise: receiving a conditioning input; processing the conditioning input using an encoder neural network to generate an encoder network output, and wherein processing the diffusion model input that comprises the current continuous representation using the diffusion model to generate the diffusion model output comprises: processing the diffusion model input using the diffusion model while the diffusion model is conditioned on the encoder network output to generate the diffusion model output.

The diffusion model input may comprise: (i) the current continuous representation, (ii) the embeddings at the one or more given output positions selected based on the one or more conditioning tokens, and (iii) a sequence of Boolean conditioning masks that identifies which positions in the plurality of output positions are the one or more given output positions.

The diffusion model input may further comprise the respective interpolated embeddings for the subset of the plurality of output positions.

The diffusion model input may further comprise data specifying a noise level.

The method may further comprise determining the noise level by: selecting a time step for the reverse diffusion step; applying time warping to the selected time step by evaluating a monotonic piecewise linear function over the selected time step to determine a warped time step; and determining the noise level from the warped time step.

Obtaining the current continuous representation of the output sequence may comprise using a current continuous representation updated as of an immediately preceding reverse diffusion step as the current continuous representation of the output sequence at the reverse diffusion step.

The diffusion model may be an attention-based neural network that includes one or more attention neural network layers.

The method may further comprise, after performing the multiple reverse diffusion steps: processing a final diffusion model input that comprises the current continuous representation that has been updated as of a last reverse diffusion step in the multiple reverse diffusion steps using the diffusion model to generate a final diffusion model output, wherein the final diffusion model output comprises, for each of the plurality of output positions, a respective final initial score for each of the plurality of embeddings in the vocabulary of embeddings; selecting, for each of the plurality of output positions, an embedding from the vocabulary of embeddings using the respective final initial scores; and generating the output sequence that includes discrete tokens corresponding to the selected embeddings.

The method may further comprise, after performing the multiple reverse diffusion steps: selecting, for each of the plurality of output positions, an embedding from the vocabulary of embeddings having a nearest distance to an embedding in the current continuous representation at the output position that has been updated as of the last reverse diffusion step in the multiple reverse diffusion steps; and generating the output sequence that includes discrete tokens corresponding to the selected embeddings.

The diffusion model may be trained by optimizing a cross-entropy loss between the probability distribution over the plurality of embeddings in the vocabulary of embeddings that has been generated using the diffusion model output and a ground truth probability distribution over the plurality of embeddings in the vocabulary of embeddings.

The embeddings in the vocabulary of embeddings may be learned jointly with a training of the diffusion model by backpropagating gradients of the cross entropy loss computed with respect to parameters of the diffusion model into the embeddings.

The discrete tokens may comprise text characters, symbols, or signals.

The diffusion model may be configured to perform one or more of: a language modelling task comprising a prompt completion and/or infilling task, or a machine translation task, a speech transcription task, a video transcription task, an image captioning task, or an agent control task.

According to another aspect, there is provided a system comprising one or more computers and one or more storage devices storing instructions that are operable, when executed by the one or more computers, to cause the one or more computers to perform the operations of any of the above methods.

According to another aspect, there is provided a computer storage medium encoded with instructions that, when executed by one or more computers, cause the one or more computers to perform the operations of any of the above methods.

Particular embodiments of the subject matter described in this specification can be implemented so as to realize one or more of the following advantages. This specification describes a framework for generative modelling of data with any of a variety of diffusion models that are continuous in time space, input space, or both. The described framework provides for effective, continuous diffusion on data, such as textual data, that is inherently discrete to attain competitive performance on a wide range of conditional and unconditional discrete data generation tasks.

The described framework offers model architectural flexibility and adaptivity of the denoising procedure when generating discrete output data. Specifically, the described framework enables trading off the computational cost and sample quality at sampling time by choosing the appropriate number of iterative refinement steps, without requiring retraining or finetuning. This is more advantageous than generating discrete output data using existing autoregressive models, where the number of steps is necessarily the same as the length of the sequence to be generated. Moreover, under the described framework, the same diffusion model could be used on a variety of different hardware device types and/or for a number of different latency requirements (e.g., where fast responses needed or compute is limited due to server demand surge, reduce quality by fewer iterations with diffusion model but still provide whole result, whereas autoregressive models would not provide whole result.

Advantageously, by using score interpolation (e.g., rather than score matching) where the diffusion model is configured to compute the score function estimates used during the iterative de-noising process by interpolating between embedding values of a continuous representation of a discrete output sequence, the described framework allows for end-to-end training of the diffusion model as well as the latent embeddings by using a single, cross-entropy loss function.

Moreover, time warping, an active learning technique which automatically adapts the distribution of noise levels sampled during training, can be used to further improve the training efficiency of the diffusion model. Implementing the framework for generative modelling of discrete data thus requires reduced consumption of computational resources, e.g., reduced processor cycles, reduced memory, reduced power consumption, relative to existing approaches.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example data generation system during inference.

FIG. 1B is a block diagram of an example data generation system during training.

FIGS. 2A-D show example operations performed by components of a data generation system.

FIG. 3 is a flow diagram of an example process for generating an output sequence.

Like reference numbers and designations in the various drawings indicate like elements.

### DETAILED DESCRIPTION

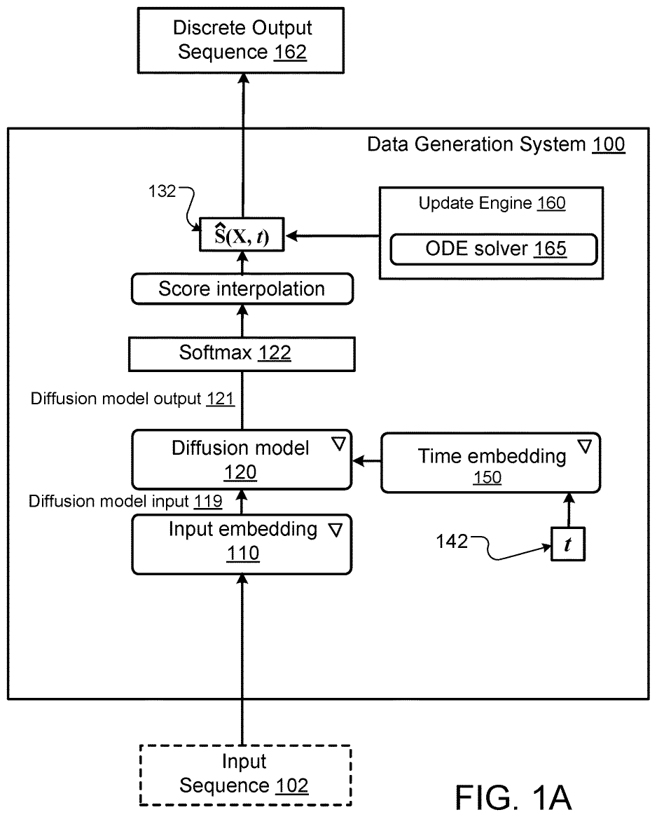

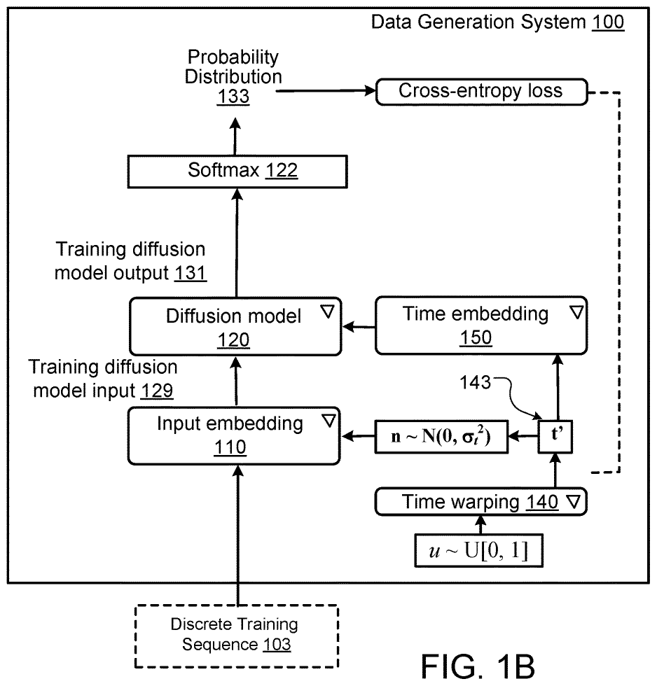

FIG. 1A is a block diagram of an example data generation system 100 during inference. The data generation system 100 is an example of a system implemented as computer programs on one or more computers in one or more locations, in which the systems, components, and techniques described below can be implemented.

The data generation system 100 is a system that generates a discrete output sequence 162 in response to received requests. The data generation system 100 can store the discrete output sequence 162 in an output data repository or provide the discrete output sequence 162 for use for some other immediate purpose. For example, the data generation system 100 can then output the discrete output sequence 162 for presentation, e.g., on a client device that submitted the data generation request.

The discrete output sequence 162 includes multiple discrete tokens. Each discrete token can be an individual, discrete data item. In this specification, continuous data refers to data that may take on any value within a specified range, constrained only by the precision of the numerical format used by a computer system. In contrast, discrete data have additional constraints that further limit the possible values that the data may take on within the specified range beyond those possible values in the numerical format used by the computer system.

In one example, the discrete output sequence 162 includes multiple tokens from a finite number of possible tokens.

For example, the discrete output sequence 162 can include a respective token from a vocabulary of discrete tokens at each of multiple positions. The vocabulary of tokens can include any of a variety of discrete tokens that represent text, symbols, or signals. For example, the vocabulary of discrete tokens can include one or more of characters, sub-words, words, punctuation marks, numbers, or other symbols that appear in a corpus of text. The text can, for example, be natural language text or computer program code.

In some examples, the discrete output sequence 162 represents audio data. The audio data may include spoken words e.g. characterizing a waveform of the audio in the time domain or in the time-frequency domain. In some examples, the discrete output sequence 162 can be a representation of phonemes for a text-to-speech (TTS) case or a midi file including notes/instrument definitions. In some examples, the discrete output sequence 162 represents text. In one example, the discrete output sequence 162 is converted by a text-to-speech converter to form an audio signal. In some examples, the discrete output sequence 162 represents a sequence of actions to be performed by an agent e.g. a mechanical agent in a real-world environment implementing the actions to perform a mechanical task.

In some cases, the data generation system 100 can be configured as an unconditional output sequence generation system that generates discrete output sequences 162 unconditioned, i.e., without conditioning on any conditioning input. In these cases, the discrete output sequences 162 generated by the system 100 approximate samples of a distribution of training input sequences that were used during the training of the data generation system 100.

In other cases, the data generation system 100 can be configured as a conditional output sequence generation system that generates discrete output sequences 162 conditioned on an input sequence 102.

In some of these cases, the input sequence 102 includes a discrete input sequence. Like the discrete output sequence 162, the discrete input sequence can include one or more tokens selected from a vocabulary of tokens. The vocabulary of tokens can include any of a variety of discrete tokens that represent text, symbols, or signals.

In others of these cases, the input sequence 102 includes a continuous input sequence (that is, an input sequence of values which are each continuous values), e.g., that represents a sequence of pixels of an image (e.g. one or more color intensity values per pixel) which may be a still image or video (e.g. the continuous input sequence may comprise portions for each of a plurality of images (image frames of the video), and each portion may successively be one or more color intensity values for each pixel), or that represent a waveform of audio or a spectrogram of an audio.

When configured as a conditional output sequence generation system, for example, the data generation system 100 can receive an input sequence 102 that includes text data, additional data other than text, e.g., data that represents an image, video, speech, etc., or both, and generate a discrete output sequence 162 that is a sequence of text, e.g., a completion (e.g., infilling) of the input sequence 102, an expansion of the input sequence 102, a response to a question posed in the input sequence 102, a sequence of text that is about a topic specified by the input sequence 102, a text description of the data of the different data type, e.g., a text caption of an image, a transcription of an audio, a transcription of an audio included in one or more video frames, and so on.

As another example, the data generation system 100 can receive an input sequence 102 that includes one or more code segments and to generate a discrete output sequence 162 that includes code segments conditioned on the input sequence 102, e.g., one or more code segments that, when combined with the code segments included in the input sequence 102, constitutes an executable application, program, object, or sequence of instructions.

In both cases, it will be appreciated that text (both natural language text and computer program code), symbols, and signals are understood as merely examples of discrete data for illustration, and the discrete tokens can be discrete data items in many other formats or modalities. For example, the discrete output sequence 162 can be or include a sequence of biological data (e.g., a sequence of gene expressions), a sequence of electronic health record data (e.g., a sequence of health events), a sequence of clinical procedure data (e.g., a sequence of physician orders, clinical documentation, notes, diagnosis codes, medications, etc.), and so on.

In one example, an input may be received in the form of an audio (speech) signal, captured by a microphone, which is converted by a speech-to-text converter to form the input sequence 102.

In some examples, the input sequence 102 of discrete tokens comprises tokens representing an audio data input including spoken words e.g. characterizing a waveform of the audio in the time domain or in the time-frequency domain.

In another example, the output sequence 163 of discrete tokens represents a sequence of actions to be performed by an agent. The agent can be, e.g., a mechanical agent, a real-world or simulated robot, a control system for an industrial facility, or a control system that controls a different kind of agent. The actions may be discrete control inputs to control a robot, e.g., control commands selected from a set of control commands, for the agent or the autonomous or semi-autonomous land or air or sea vehicle.

In another example, the input sequence 102 can be a query input comprising an input token string and also at least one data item.

For example, the data item(s) may be image(s). Each data item may be a still image—e.g. the data item may be pixel values (e.g. red-green-blue (RGB) values) for each pixel of a pixel array. Alternatively, one or more of the data items may be video images—e.g. the data may be, for each of multiple frames, pixel values for each pixel of a respective array. The image(s) may be captured by imaging the real world, by a still or video camera. In another possibility, the data item(s) may be sound signal(s) (a sound signal is audio data representing values of an audio waveform at each of a plurality of times, e.g. the sound captured by a microphone during a period of time. In a further possibility, the data items may be video images with an accompanying respective soundtrack.

In particular, to generate discrete output sequence 162, the data generation system 100 uses an input embedding engine 110, a diffusion model neural network 120, a time embedding neural network 150, and an update engine 160 to generate the discrete output sequence 162 across multiple reverse diffusion steps by performing a reverse diffusion process. The discrete output sequence 162 is generated after the last reverse diffusion step of the reverse diffusion process.

Prior to the beginning of the reverse diffusion process, the input embedding engine 110 initializes a continuous representation, i.e., generates an initial continuous representation, of the discrete output sequence 162. The continuous representation can include multiple embeddings. An “embedding” can generally refer to an ordered collection of numerical values, e.g., a vector, matrix, or other tensor of numerical values. For example, each embedding can include multiple numerical values respectively for multiple embedding dimensions (e.g., 128, 256, or 512 embedding dimensions). As such, the continuous representation provides a numerical encoding of the discrete input sequence 102 in a continuous embedding space.

The dimension of the initial continuous representation is dependent on the dimension of the discrete output sequence 162 (e.g., dependent on the number of tokens included in the discrete output sequence 162). In cases where the discrete output sequence 162 includes a discrete token at each of multiple output positions, the initial continuous representation of the discrete output sequence 162 can include the same number of output positions as the discrete output sequence 162, and can include one embedding at each output position.

When configured as an unconditional output sequence generation system, the input embedding engine 110 generates the initial continuous representation by sampling the initial numerical values for each of the multiple embeddings included in the initial continuous representation from a corresponding noise distribution, e.g., a Gaussian distribution or another predetermined distribution. The initial continuous representation therefore includes the multiple embeddings, with the initial values for each embedding being sampled from a corresponding noise distribution.

When configured as a conditional output sequence generation system, the input embedding engine 110 processes the received discrete input sequence 102 to generate one or more conditioning embeddings that each include learned numerical values. The input embedding engine 110 then generates the initial continuous representation based on using the conditioning embeddings as the embeddings at some of the output positions in the initial continuous representation, and on sampling the initial numeric values included in embeddings at the remaining output positions in the initial continuous representation from a corresponding noise distribution, e.g., a Gaussian distribution or another predetermined distribution.

In particular, the input embedding engine 110 can generate the conditioning embeddings from the received discrete input sequence 102 by selecting, from a vocabulary of embeddings, a respective embedding that maps to each discrete input token included in the discrete input sequence 102, and then assigning the selected respective embeddings to some of the multiple output positions in the initial continuous representation.

The vocabulary of embeddings maintained by the input embedding engine 110 can include a respective embedding corresponding to each discrete token in the vocabulary of discrete tokens, thereby defining a mapping between the vocabulary of discrete tokens and the vocabulary of embeddings. Each embedding in this vocabulary can have numerical values that are learned during the training of the data generation system 100.

After the input embedding engine 110 has generated the initial continuous representation of the discrete output sequence 162, the data generation system 100 includes the initial continuous representation in a diffusion model input 119 to be provided as input to the diffusion model neural network 120 for further processing.

The diffusion model input 119 also includes other data. In particular, at each reverse diffusion step, the diffusion model input 119 also includes a corresponding time step embedding that is generated by the time embedding neural network 150 from data defining a corresponding time step t 142. The time step t 142 (typically running from t=tₘₐₓ to t=tₘᵢₙ) identifies the current reverse diffusion step in the reverse diffusion process. In general, different reverse diffusion steps across the reverse diffusion process will correspond to varying noise levels in the reverse diffusion process, and thus the time step t 142 also identifies a noise level that corresponds to the current reverse diffusion step that is currently being performed.

The time embedding neural network 150 can have any appropriate neural network architecture that allows the neural network to map the data defining a time step t 142 to the time embedding. A particular example architecture will be described further below, but more generally, the time embedding neural network 150 can include any appropriate types of neural network layers (e.g., embedding layers, fully connected layers, convolutional layers, and so forth) in any appropriate number (e.g., 1 layer, or 5 layers, or 10 layers) and connected in any appropriate configuration (e.g., as a directed graph of layers).

At each reverse diffusion step, the diffusion model neural network 120 processes the diffusion model input 119 to generate a diffusion model output 121, and then uses the diffusion model output 121 generated by the diffusion model neural network 120 to update the continuous representation of the discrete output sequence 162, i.e., to generate an updated continuous representation of the discrete output sequence 162, as of the reverse diffusion step.

The diffusion model neural network 120 can have any appropriate architecture that allows the neural network to map a diffusion model input 119, which includes a current continuous representation of the discrete output sequence 162 (as of a given reverse diffusion step), to the diffusion model output 121.

A particular example architecture of diffusion model neural network 120 will be described further below, but more generally, the diffusion model neural network 120 can be and/or comprise a neural network having any appropriate architecture. For example, the diffusion model neural network 120 can include one or more fully connected layers. As another example, the diffusion model neural network 120 can be an attention neural network, e.g., can have a Transformer or other architecture that includes one or more attention layers. An attention layer is a layer that includes an attention mechanism, e.g., a scaled dot-product attention mechanism. For example, the diffusion model neural network 120 can include one or more self-attention layers (e.g., one or more multi-head self-attention layers), one or more cross-attention layers, or both. These examples are not exhaustive, and it may be readily appreciated that the diffusion model neural network 120 may include any appropriate types of neural network layers, in any appropriate number, and connected in any appropriate configuration.

In particular, the diffusion model neural network 120 has been trained using a score interpolation objective on a set of training data to generate the diffusion model output 121. In other words, the data generation system 100 obtains a score function estimate from the diffusion model output 121 through linear interpolation, and then uses the score function estimate for sampling with an ordinary differential equation (ODE) solver 165 to update the current continuous representation of the discrete output sequence 162.

During training, using such a score interpolation objective, e.g., instead of a score matching objective, can be advantageous, at least because score interpolation allows for the use of a cross-entropy loss during the training, which in turn enables end-to-end training of the data generation system 100—including the diffusion model neural network 120 and the embeddings included in the input embedding engine 110—with a single loss function. This may improve the effectiveness of the training by allowing these two system components to co-adapt.

On the other hand, if the score matching objective were to be used, joint training of the diffusion model neural network 120 and the embeddings included in the input embedding engine 110 might result in collapse of the embedding space (where a large number of embeddings correspond to the same vector.)

To facilitate score interpolation, at each reverse diffusion step, the diffusion model output 121 includes multiple logit vectors respectively for the multiple output positions of the output sequence 162. Each logit vector includes a respective initial score for each of the multiple embeddings in the vocabulary of embeddings. Thus, for a given output position, and for a given embedding vector, the respective initial score included in the logit vector may represent a predicted probability of a discrete token which maps to the given embedding vector to situate at the given output position.

The data generation system 100 applies a softmax function 122 over the logit vectors included in the diffusion model output 121 to generate, for each of the multiple output positions, a probability distribution over the multiple embeddings in the vocabulary of embeddings at the reverse diffusion step.

The data generation system 100 uses the probability distributions to generate a score function estimate 132 through linear interpolation, as will be explained in more detail below, and then uses the update engine 160 to update the current continuous representation of the output sequence by applying an ODE solver 165 to the score function estimate 132.

One way the update engine 160 can use the score function estimate to update the current continuous representation is by applying an ordinary differential equation (ODE) solver 165 to the score function estimate to update the current continuous representation.

In such an approach the update engine 160 can use any appropriate ODE solver to update the current continuous representation. For example, the ODE solver 165 can be an ODE solver that uses a Euler's 1^{st} order method or a Heun's 2^{nd} order method (e.g., one of the ODE solvers described in T. Karras, et al. Elucidating the design space of diffusion-based generative models. arXiv preprint arXiv: 2206.00364, 2022). As another example, the ODE solver 165 can be an ODE solver that uses a stochastic method or a more advanced method, e.g., the ODE solver as described in C. Lu, et al. Dpmsolver: A fast ode solver for diffusion probabilistic model sampling in around 10 steps. arXiv preprint arXiv:2206.00927, 2022.

By repeatedly using the generate the diffusion model neural network 120 to generate, for each of multiple reverse diffusion steps across the reverse diffusion process, a diffusion model output 121 that defines a corresponding score function estimate for the reverse diffusion step, and repeatedly using the update engine 160 to use the score function estimate to update the current continuous representation for each reverse diffusion step, the data generation system 100 can iteratively update the initial continuous representation to generate a final continuous representation. The final continuous representation of the discrete output sequence 162 is therefore the continuous representation that has been updated as of the last reverse diffusion step of the reverse diffusion process.

The initial continuous representation has the same dimensionality as the updated continuous representation (and, analogously, the final continuous representation) but has different values. That is, the initial continuous representation includes multiple embeddings and the updated continuous representation (and, analogously, the final continuous representation) includes the same number of embeddings, but the numeric values included in at least some of these embeddings will be different.

After having performed the multiple reverse diffusion steps, the data generation system 100 can generate the discrete output sequence 162 from the final continuous representation of the discrete output sequence 162. The discrete output sequence 162 includes a respective discrete token selected from a vocabulary of discrete tokens at each of the multiple output positions.

In some cases, the data generation system 100 can do this by selecting an embedding for each of the multiple output positions from the vocabulary of embeddings using the final continuous representation of the discrete output sequence 162.

Specifically, the data generation system 100 selects, for each of the multiple output positions in the discrete output sequence 162, an embedding from the vocabulary of embeddings that has a nearest distance to an embedding in the final continuous representation, and then generates the discrete output sequence 162 that includes the discrete tokens that map respectively to the selected embeddings according to the mapping defined by the vocabulary of embeddings maintained by the input embedding engine 110.

For example, for a given output position, the data generation system 100 can use a distance measure like Euclidean distance or cosine similarity to determine which embedding in the vocabulary of embeddings is the “closest” embedding to the embedding in the final continuous representation.

In some other cases, the data generation system 100 runs the diffusion model neural network 120 for an additional time after the last reverse diffusion step to generate the discrete output sequence 162. Specifically, the data generation system 100 processes a final diffusion model input that includes the final continuous representation using the diffusion model neural network 120 to generate a final diffusion model output. The final diffusion model output includes, for each of the multiple output positions, a respective final initial score for each of the multiple embeddings in the vocabulary of embeddings.

Next, the data generation system 100 uses the respective final initial scores to select, for each of the multiple output positions, an embedding from the vocabulary of embeddings, and then generates the discrete output sequence 162 that includes the discrete tokens that map respectively to the selected embeddings according to the mapping defined by the vocabulary of embeddings maintained by the input embedding engine 110.

For example, for a given output position, the data generation system 100 can greedily select the highest-scoring embedding from the vocabulary of embeddings, or can sample, e.g., using nucleus sampling or another sampling technique, an embedding from the vocabulary of embeddings according to their respective final initial scores.

FIG. 1B is a block diagram of an example data generation system 100 during training. In general, the data generation system 100 can be trained in an end-to-end manner using a single loss function, e.g., a cross-entropy loss function, a focal loss function, or a hinge loss function, on a set of training data to determine the trained values for the embeddings included in the vocabulary of embeddings maintained by the input embedding engine 110, and the trained values for the parameters of the diffusion model neural network 120 and the time embedding neural network 150.

For example, the set of training data can include multiple discrete training sequences. Each discrete training sequence includes a respective token from a vocabulary of tokens at each of multiple positions. The vocabulary of tokens can include any of a variety of discrete tokens that represent text, symbols, or signals.

In one example, the set of training data can include the MassiveText dataset as descried in J. W. Rae, et al. Scaling language models: Methods, analysis & insights from training gopher. arXiv preprint arXiv:2112.11446, 2021. In another example, the set of training data can include the C4 dataset as described in Raffel et al., “Exploring the limits of transfer learning with a unified text-to-text transformer”, J. Mach. Learn. Res., 21:140:1-140:67, 2020, the entire contents of which are incorporated by reference herein. In another example, the set of training data may include a set of training data items, in which each training data item comprises an audio file, image file and/or video file (e.g. audio files/image files and/or video files captured from a real-world environment by a microphone or camera) and appropriate captions (e.g. in the case the training data item comprises an audio file; or in the case that the training data item comprises an image or video file depicting one or more elements in a location, a caption describing the element(s)). In another example, the set of training data may include a set of training data items, in which each training data item comprises an audio file, image file and/or video file (e.g. audio files/image files and/or video files captured from a real-world environment by a microphone or camera) and appropriate command to a real-world agent, such as a robot. In another example, the set of training data may include a set of training data items, in which each training data item comprises a textual input, and an audio file, image file and/or video file (e.g. audio files/image files and/or video files captured from a real-world environment by a microphone or camera) which are an appropriate response to the textual input (e.g. if the textual input is “provide a skiing image”, an image depicting skiing). In another example, the set of training data may include a set of training data items, in which each training data item comprises a textual input in a first natural language, and a textual output, which is a translation of the textual input into a second natural language.

The data generation system 100 uses the discrete training sequences included in set of training data to train the aforementioned components of the system 100. More specifically, for a given discrete training sequence 103 selected from the set training data, the system uses the input embedding engine 110 to generate, based on the given discrete training sequence 103, a continuous representation of the given discrete training sequence 103, and additionally adds time-dependent noise to the continuous representation to generate a noisy continuous representation of the given discrete training sequence 103.

The data generation system 100 then performs a (partial) reverse diffusion step on the noisy continuous representation of the given discrete training sequence 103. That is, the system processes a training diffusion model input 129 that includes the noisy continuous representation of the given discrete training sequence using the diffusion model neural network 120 to generate a training diffusion model output 131, and then processes the training diffusion model output 131 using a softmax function to generate, for each of the multiple output positions of the given discrete training sequence, a probability distribution 133 over the plurality of embeddings in the vocabulary of embeddings. Unlike during inference, the system need not apply the update engine 160 to generate an updated continuous representation of the given discrete training sequence using the probability distributions 133.

FIG. 1B illustrates that the data generation system 100 then computes a cross-entropy loss function that evaluates, for each output position, a cross-entropy loss between (i) the probability distribution 133 over the plurality of embeddings in the vocabulary of embeddings that has been generated using the training diffusion model output 131 and (ii) a ground truth probability distribution over the plurality of embeddings in the vocabulary of embeddings.

For each output position, the ground truth probability distribution can for example be a probability distribution that assigns a higher probability score to a ground truth embedding that maps to a particular token that situates at the output position in the given discrete training sequence 103, and lower probability scores to remaining embeddings that map respectively to other tokens in the vocabulary of tokens that do not situate at the output position in given discrete training sequence 103.

The data generation system 100 then updates the parameter values of the diffusion model neural network 120 and the time embedding neural network 150 by using an appropriate machine learning training technique, e.g., a gradient descent with backpropagation training technique that uses a conventional optimizer, e.g., stochastic gradient descent, RMSprop, or Adam optimizer, to optimize the cross-entropy loss function.

Moreover, data generation system 100 updates the values of the embeddings included in the vocabulary of embeddings maintained by the input embedding engine 110 by backpropagating gradients of the cross-entropy loss computed with respect to parameters of the diffusion model neural network 120 into the embeddings included in the vocabulary of embeddings. Thus, the vocabulary of embeddings is learned jointly with the training of the diffusion model neural network 120.

During training, the data generation system 100 can incorporate any number of techniques to improve the efficiency, the effectiveness, or both of the training process.

In a particular example, the data generation system 100 can adopt an active learning strategy to improve the efficiency by automatically adapting the distribution of noise levels sampled during training.

FIG. 1B thus illustrates that the data generation system 100 makes use of an optional time warping engine 140 during training. In the absence of this time warping, there is pre-determined one-to-one relationship between reverse diffusion steps carried out by the diffusion model and a level of noise which is a function o (t) of a “time” denoted by t, and discretized as a number of time steps, corresponding to the results of respective reverse diffusion steps. The time t corresponds to a time in a diffusion process which is modeled (in reverse) by the diffusion model. In the diffusion process, the continuous representation is gradually corrupted by an increasing level of noise. In the reverse diffusion process, each reverse diffusion step performed by the diffusion model corresponds to an updating of the continuous representation in which the time t is updated a lower value of t, with a corresponding lower value of noise, σ(t). The updating of the continuous representation is modelled as a differential equation, which, as mentioned, is solved by the ODE solver 165. In this diffusion process, time t=0 (or more generally tₘᵢₙ) may be an (ideal) continuous representation (e.g. corresponding to a desired discrete output sequence 162) without noise, and at later time T (or tₘₐₓ) the diffusion has produced fully corrupted data. As noted, at each time t, the level of noise is σ(t), also denoted here by σₜ, which may be an increasing function of t, or indeed equal to t. By the time warping, t is mapped to a value t′, such that in a reverse diffusion step corresponding to time step t, the level of noise applied is σ(t′) instead of σ(t).

In an example, in the case of warping, for a given reverse diffusion step during training, the time warping engine 140 selects a time step for the given reverse diffusion step based on sampling a time step t uniformly from a possible range of time steps (between t=tₘᵢₙ to t=tₘₐₓ), and applying time warping to the sampled time step t by evaluating a monotonic piecewise linear function F over the sampled time step t to determine a warped time step t′ 143. The warped time step t′ 143 identifies an adapted noise level σ(t′) for the given reverse diffusion step that is currently being performed during training.

Such a monotonic piecewise linear function can be parameterized by a set of learnable parameters, e.g., by dividing both the input and output ranges of the function into a fixed number of bins and applying one of the parameterization techniques described in C. Durkan, A., et al., Neural spline flows. Advances in neural information processing systems, 32, 2019, and in T. Müller, et al., Neural importance sampling. ACM Transactions on Graphics (TOG), 38(5):1-19, 2019, the entire contents of which are incorporated by reference herein.

When such an active learning strategy is used, the time-dependent noise added by the input embedding engine 110 to the continuous representation to generate the noisy continuous representation of the given discrete training sequence 103 is therefore an adapted noise determined according to the non-uniform, warped time step t′, i.e., instead of a uniformly sampled time step t. Moreover, the data identifying the warped time step t′ is received and processed by the time embedding neural network 150 when generating the time step embedding to be included in the training diffusion model input 129.

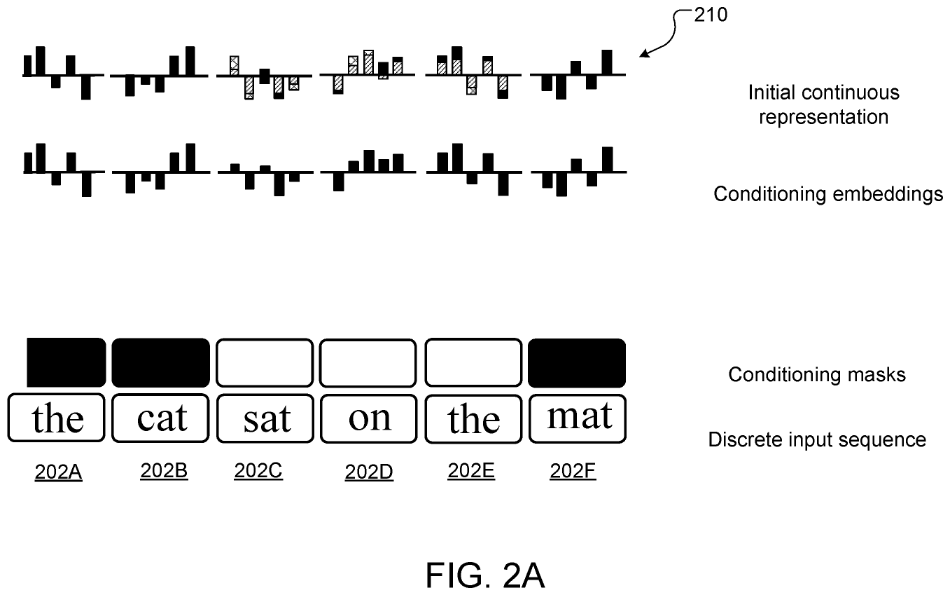

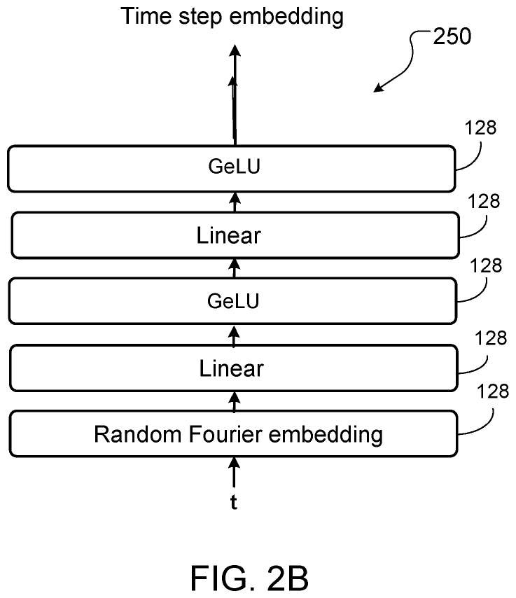

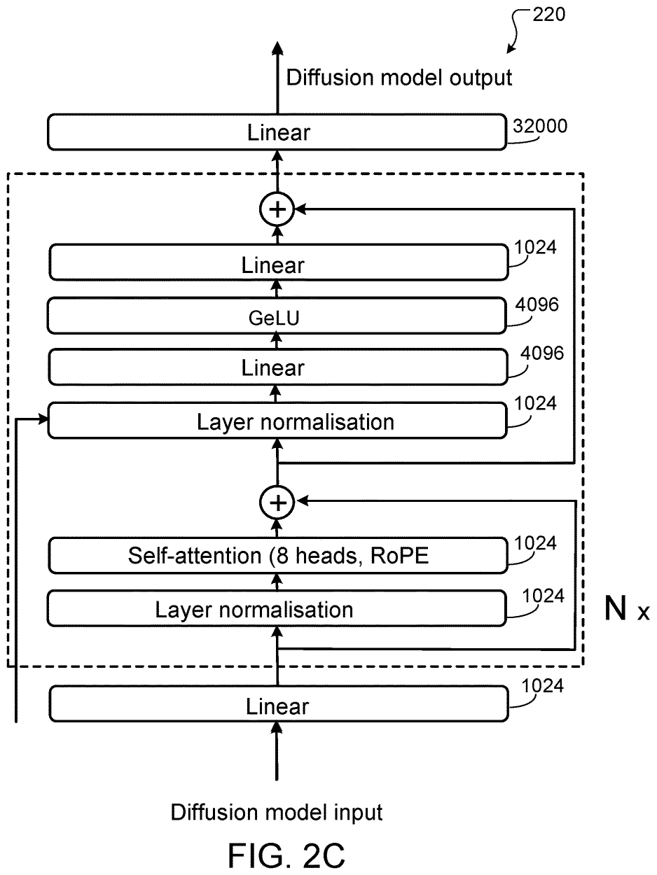

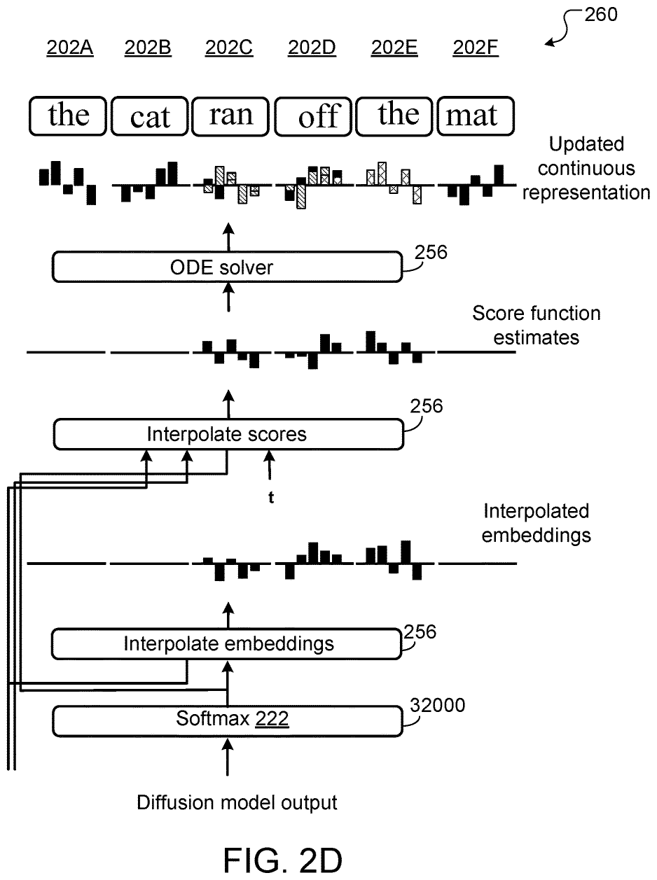

FIG. 2A shows example operations performed by an input embedding engine 210. The input embedding engine 210 can be the same or similar to the input embedding engine 110 included in the data generation system 100 of FIG. 1.

At a high level, prior to the beginning of a reverse diffusion process, the input embedding engine 210 can perform these operations to generate an initial continuous representation of a discrete output sequence that includes multiple output positions 202A-202F, and to generate a sequence of Boolean conditioning masks, both of which will be included as a part of a diffusion model input for the first reverse diffusion step.

The input embedding engine 210 receives a discrete input sequence that includes multiple conditioning tokens. In the example of FIG. 2A, the discrete input sequence includes three conditioning tokens: “the”, “cat”, and “mat”.

To generate the initial continuous representation, the input embedding engine 210 selects, from a vocabulary of embeddings, a respective embedding (also referred to as a “conditioning embedding”) that maps to each conditioning token included in the discrete input sequence, and then assigns the selected conditioning embeddings to some of the multiple output positions (also referred to as the “clean” output positions) in the initial continuous representation. As mentioned above, the selected conditioning embeddings have learned numeric values that have been learned during the training of the data generation system.

For example, FIG. 2A illustrates that the initial continuous representation includes conditioning embeddings that map respectively to the conditioning tokens of “the”, “cat”, and “mat” at clean output positions 202A, 202B, and 202F.

The input embedding engine 210 generates the embeddings at each remaining output position (also referred to as the “noisy” output position) in the initial continuous representation by sampling the initial numeric values included in each such embedding from a corresponding noise distribution, e.g., a Gaussian distribution or another predetermined distribution.

For example, FIG. 2A illustrates that the initial continuous representation includes embeddings that have randomly initialized numeric values at noisy output positions 202C, 202D, and 202E.

The input embedding engine 210 also generates a sequence of Boolean conditioning masks. The sequence of Boolean conditioning masks identifies which positions in the multiple output positions are the clean output positions, and which positions are the noisy output positions. For example, the sequence of Boolean conditioning masks can include zero for each clean output position, and one for each noisy output position, or vice versa.

FIG. 2B shows example operations performed by a time embedding neural network 250. The time embedding neural network 250 can be the same or similar to the time embedding neural network 150 included in the data generation system 100 of FIG. 1.

The time embedding neural network 250 processes data defining a time step t to generate a time step embedding. The time step t identifies a noise level that corresponds to the current reverse diffusion step in the reverse diffusion process. The time embedding neural network can have any architecture that allows the neural network to map data defining the time step t to a time step embedding.

In the example of FIG. 2B, the time embedding neural network 250 includes a random fourier embedding layer, followed by a linear layer, followed by a GeLU activation layer, followed by another linear layer, and followed by another GeLU activation layer. Each layer includes 128 units. The time embedding neural network 250 processes the data defining a time step t through these layers to generate the time step embedding.

In other examples, however, the time embedding neural network 250 can include different numbers of layers, different types of layers, or both.

FIG. 2C shows example operations performed by a diffusion model neural network 220. The diffusion model neural network 220 can be the same or similar to the diffusion model neural network 120 included in the data generation system 100 of FIG. 1.

In the example of FIG. 2C, the diffusion model neural network 220 is configured as a Transformer neural network that includes a total of N attention blocks arranged between an input linear layer with 1024 units, and an output linear layer with 32000 units. Each attention block includes a self-attention layer that has 8 attention heads and a ROPE embedding layer, followed by two linear layers separated by a GeLU activation layer. Each attention block also includes two layer normalization layers.

In other examples, however, the diffusion model neural network can include different types of layers, different numbers of layers, or both. For example, the diffusion model neural network can include different numbers of attention blocks, each including the same or different layers.

At each reverse diffusion step, the diffusion model neural network 220 receives a diffusion model input. The diffusion model input can include (i) a current continuous representation of the output sequence, (ii) the conditioning embeddings at the clean output positions that have been selected by the input embedding engine 210 based on the received discrete input sequence, (iii) a sequence of Boolean conditioning masks.

For the very first reverse diffusion step, the current continuous representation is the initial continuous representation that has been generated by the input embedding engine 210. For any subsequent reverse diffusion step, the current continuous representation is the updated current continuous representation that has been generated in the immediately preceding reverse diffusion step. In either case, the current embeddings included in the current continuous embedding are not constrained to be any of the embeddings in the vocabulary of embeddings.

Optionally, the diffusion model input also includes a self-conditioning input. The self-conditioning input includes the respective interpolated embeddings for the noisy positions of the multiple output positions. Generating the interpolated embeddings will be explained further below.

The diffusion model neural network 220 processes the diffusion model input to generate a diffusion model output. The diffusion model output includes, for each of the multiple output positions, a respective initial score for each of the multiple embeddings in the vocabulary of embeddings.

To that end, an output layer of the diffusion model neural network 220 can include a respective unit corresponding to each embedding. For example, as illustrated in FIG. 2C, in implementations where the input embedding engine 210 uses a vocabulary composed of 32000 tokens associated with a SentencePiece tokenizer (as described in Kudo et. al., “Sentencepiece: A simple and language independent subword tokenizer and detokenizer for neural text processing”, In EMNLP (Demonstration), pp. 66-71, Association for Computational Linguistics, 2018), the output layer can be a linear layer with 32000 units, with each unit configured to generate a respective initial score for an embedding that maps to one of the 32000 tokens.

FIG. 2D shows example operations performed by a softmax layer 222 and an update engine 260. The softmax layer 222 and update engine 260 can be the same or similar to the softmax layer 122 and the update engine 160 included in the data generation system 100 of FIG. 1, respectively.

At each reverse diffusion step, the softmax layer 222 applies a softmax function over the diffusion model output generated by the diffusion model neural network 220 at the reverse diffusion step to generate the probability distribution p over the multiple embeddings in the vocabulary of embeddings for each of the multiple output positions. The probability distribution p can include a respective probability score for each embedding in the vocabulary of embeddings.

The update engine 260 can then use the probability distributions p to update, i.e., de-noise, the current continuous representation of the output sequence as of the reverse diffusion step in accordance with a score function estimate for the output sequence that is computed from the probability distributions p.

For a given output position, the score function estimate is defined as:

$$\hat{s} ( x , t ) = {\sum }_{i = 1}^{V} p ( {x}_{0} = {e}_{i} \vert x , t ) s ( x , t \vert {x}_{0} = {e}_{i} ) ,$$

where eᵢ represents an embedding that maps to token i in the vocabulary V of tokens, x₀ is the ground truth embedding (that maps to a particular token that should situate at the given output position), x is the current embedding for the given output position in the current continuous representation, and t is the time step that identifies the reverse diffusion step.

Note that the right-hand side of this equation is also equivalent to the expectation [symbol] ₚ₍ₓ_{₀}_{|x,t}) [s(x, t|x₀)], and conditional score function s(x, t|x₀) can be defined as

$$s ( x , t \vert {x}_{0} ) = \frac{{x}_{0} - x}{{t}^{2}} ,$$

which is affine in x₀.

Therefore, the update engine 260 can compute the score function estimate as:

$$\hat{s} ( x , t ) = \frac{{𝔼}_{p ( {x}_{0} \vert x , t )} [ {x}_{0} ] - x}{{t}^{2}} .$$

In other words, for each of the noisy output positions in the current continuous representation of the output sequence, the update engine 260 first uses the probability distributions and the vocabulary of embeddings to determine a respective interpolated embedding \hat{x}₀:= [symbol] ₚ₍ₓ_{₀}_{|x,t}) [x₀], and then uses the interpolated embedding to compute the score function estimate.

The score function estimate has the form of a numerator term divided by a denominator term, where the numerator term is dependent on a difference between the interpolated embedding for the noisy output position and the current embedding for the noisy output position, and where the denominator term is dependent on the square of the time step t.

The sampling engine 260 then applies an ordinary differential equation (ODE) solver to the score function estimate to update the current continuous representation of the output sequence. The ODE solver can be any appropriate ODE solver that uses, e.g., a Euler method or a Heun method. In particular, the sampling engine 260 uses the ODE solver to evaluate the score function estimate to determine a respective updated embedding for each of the noisy output positions in the current continuous representation of the output sequence.

After the having performed the multiple reverse diffusion steps, the update engine 260 (or another component of the data generation system) can generate the discrete output sequence. One way of doing this is to use the final continuous representation of the discrete output sequence. The final continuous representation of the discrete output sequence is the updated continuous representation that has been generated in the last reverse diffusion step of the reverse diffusion process.

In this approach, the update engine 260 selects, for each of the noisy output positions, an embedding from the vocabulary of embeddings that has a nearest distance to the embedding in the final continuous representation, and then generates the discrete output sequence that includes the discrete tokens at the noisy output positions that map respectively to the selected embeddings. In the example of FIG. 2D, three tokens: “ran”, “off”, and “the” are generated respectively for the noisy output positions 202C, 202D, and 202E based on the selected embeddings.

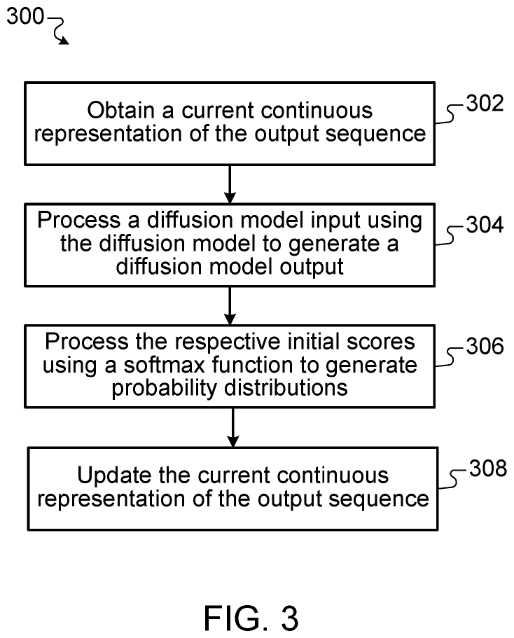

FIG. 3 is a flow diagram of an example process 300 for generating an output sequence. The output sequence includes a respective discrete token selected from a vocabulary of discrete tokens at each of multiple output positions. For convenience, the process 300 will be described as being performed by a system of one or more computers located in one or more locations. For example, a data generation system, e.g., the data generation system 100 of FIG. 1, appropriately programmed in accordance with this specification, can perform the process 300.

In general, the system can repeatedly perform one iteration of steps 302-308 at each of multiple reverse diffusion steps (referred to as the “current” reverse diffusion step below) of the reverse diffusion process to generate the output sequence.

In some cases, the number of iterations is fixed. In other cases, the system or another system can adjust the number of iterations based on a latency requirement for the generation of the output sequence, i.e., can select the number of iterations so that the output sequence item will be generated to satisfy the latency requirement. In yet other cases, the system or another system can adjust the number of iterations based on a computational resource consumption requirement for the generation of the output sequence, i.e., can select the number of iterations so that the output sequence will be generated to satisfy the requirement. For example, the requirement can be a maximum number of floating operations (FLOPS) to be performed as part of generating the output sequence.

In some cases, the number of iterations can be any number between 10 and 500, inclusive on both ends. In some cases, the number of iterations can be any number between 10 and 50, inclusive on both ends. In some cases, the number of iterations could be lower when stochastic samplers or more advanced methods are used by the ODE solver.

Prior to performing the first iteration of steps 302-308, the system generates an initial continuous representation of the output sequence, which includes the same number of output positions as the discrete output sequence. The system can generally do this by assigning a respective embedding to each of the multiple output positions.

For example, when a discrete input sequence that includes multiple tokens is received, the system can select, from a vocabulary of embeddings, conditioning embeddings that correspond respectively to the tokens included in the discrete input sequence. The vocabulary of embeddings can include a respective embedding corresponding to each discrete token in the vocabulary of discrete tokens, thereby defining a mapping between the vocabulary of discrete tokens and the vocabulary of embeddings.

In this example, the system can then generate the initial continuous representation based on using the conditioning embeddings as the embeddings at some of the output positions (the “clean” output positions) in the initial continuous representation, and on sampling the initial numeric values included in embeddings at the remaining output positions (the “noisy” output positions) in the initial continuous representation from a corresponding noise distribution, e.g., a Gaussian distribution or another predetermined distribution.

The system obtains a current continuous representation of the output sequence for the current reverse diffusion steps (step 302). The current continuous representation includes a current embedding for each of the multiple output positions.

When the current reverse diffusion step is the very first reverse diffusion step, the current continuous representation is the initial continuous representation. When the current reverse diffusion step is a subsequent reverse diffusion step, the current continuous representation is the updated continuous representation that has been generated in the immediately preceding reverse diffusion step.

In some implementations, the system applies normalization to the current embeddings in the current continuous representation. For example, the normalization can be L2 normalization.

The system processes a diffusion model input using a diffusion model neural network to generate a diffusion model output (step 304). The diffusion model input can include (i) the (normalized) current continuous representation of the output sequence, (ii) the conditioning embeddings at the clean output positions that have been selected by the system based on the received discrete input sequence, (iii) a sequence of Boolean conditioning masks, and (iv) data defining the current reverse diffusion step. The sequence of Boolean conditioning masks identifies which positions in the multiple output positions in the current continuous representation are the clean output positions, and which positions are the noisy output positions.

Optionally, in some implementations, the diffusion model input also includes a self-conditioning input. The self-conditioning input can include the respective interpolated embeddings for the noisy positions of the multiple output positions. As explained above, the respective interpolated embeddings were generated by the system in the immediately preceding reverse diffusion step to facilitate the computation of the score function estimates for the output sequence.

Further optionally, in some implementations, the diffusion model input also includes conditioning data generated from the additional data other than text, e.g., data that represents an image, video, speech, etc., that is also received by the system as a part of the conditioning input. In some of these implementations, the system can process the conditioning data using an encoder neural network to generate an encoder network output, and then include the encoder network output in the diffusion model input. Thus, the diffusion model neural network is conditioned on the encoder network output to generate the diffusion model output.

The diffusion model output includes, for each of the multiple output positions, a respective initial score for each of the multiple embeddings in the vocabulary of embeddings.

The system processes the respective initial scores using a softmax function to generate, for each of the multiple output positions, a probability distribution over the multiple embeddings in the vocabulary of embeddings (step 306). For each output position, the probability distribution can include a respective probability score for each embedding in the vocabulary of embeddings.

The system updates, using the probability distributions and the vocabulary of embeddings, the current continuous representation to generate an updated continuous representation of the output sequence for the current reverse diffusion step (step 308).

Specifically, the system can do this based on determining, using the respective probability scores and the vocabulary of embeddings, a score function estimate for the output sequence, and applying an ordinary differential equation (ODE) solver to the score function estimate. By applying the ODE solver, the system can generate a respective updated embedding for each noisy output position in the multiple output positions in the current continuous representation of the output sequence.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for generating an output sequence that comprises a respective discrete token selected from a vocabulary of discrete tokens at each of a plurality of output positions, wherein the method comprises:
initializing a continuous representation of the output sequence by assigning a respective embedding to each of one or more of the plurality of output positions, each embedding being selected from a vocabulary of embeddings that comprises a respective embedding corresponding to each discrete token in the vocabulary of discrete tokens;
repeatedly performing the following at each of multiple reverse diffusion steps:
obtaining a current continuous representation of the output sequence;
processing a diffusion model input that comprises the current continuous representation using the diffusion model to generate a diffusion model output, wherein the diffusion model output comprises, for each of the plurality of output positions, a respective initial score for each of the plurality of embeddings in the vocabulary of embeddings;
processing the respective initial scores using a softmax function to generate, for each of the plurality of output positions, a probability distribution over the plurality of embeddings in the vocabulary of embeddings that includes a respective probability score for each embedding in the vocabulary of embeddings; and
updating the current continuous representation of the output sequence using the probability distributions and the vocabulary of embeddings.

2. The method of claim 1, wherein updating the current continuous representation of the output sequence using the probability distributions and the vocabulary of embeddings comprises:
determining, using the respective probability scores and the vocabulary of embeddings, a score function estimate for the output sequence; and
updating the current continuous representation of the output sequence by applying an ordinary differential equation (ODE) solver to the score function estimate.

3. The method of claim 2, wherein updating the current continuous representation of the output sequence of the output sequence by applying the ODE solver to the score function estimate comprises:
using the ODE solver to evaluate the score function estimate to determine a respective updated embedding for at least one of a subset of the output positions in the current continuous representation of the output sequence.

4. The method of claim 2, wherein determining the score function estimate comprises:
using the probability distributions and the vocabulary of embeddings to determine a respective interpolated embedding for each of the subset of the plurality of output positions.

5. The method of claim 4, wherein determining the score function estimate for the output sequence comprises, at each of the plurality of output positions:
computing a difference between the respective interpolated embedding for the output position and a current embedding for the output position in the current continuous representation of the output sequence.

6. The method of claim 1, wherein processing the diffusion model input that comprises the current continuous representation using the diffusion model comprises:
applying normalization across the current embeddings in the current continuous representation.

7. The method of claim 1, wherein the method further comprises receiving a conditioning input sequence that comprises one or more conditioning tokens, and wherein
initializing the output sequence comprises:
selecting, from the vocabulary of embeddings, embeddings at one or more given output positions of the output positions based on the one or more conditioning tokens; and
generating initial embeddings at remaining output positions of plurality of output positions with at least some measure of randomness.

8. The method of claim 1, wherein the method further comprises:
receiving a conditioning input;
processing the conditioning input using an encoder neural network to generate an encoder network output, and wherein processing the diffusion model input that comprises the current continuous representation using the diffusion model to generate the diffusion model output comprises:
processing the diffusion model input using the diffusion model while the diffusion model is conditioned on the encoder network output to generate the diffusion model output.

9. The method of claim 7, wherein the diffusion model input comprises:
(i) the current continuous representation, (ii) the embeddings at the one or more given output positions selected based on the one or more conditioning tokens, and (iii) a sequence of Boolean conditioning masks that identifies which positions in the plurality of output positions are the one or more given output positions.

10. The method of claim 4, wherein the diffusion model input further comprises the respective interpolated embeddings for the subset of the plurality of output positions.

11. The method of claim 9, wherein the diffusion model input further comprises data specifying a noise level.

12. The method of claim 11, further comprising determining the noise level by:
selecting a time step for the reverse diffusion step;
applying time warping to the selected time step by evaluating a monotonic piecewise linear function over the selected time step to determine a warped time step; and
determining the noise level from the warped time step.

13. The method of claim 1, wherein obtaining the current continuous representation of the output sequence comprises using a current continuous representation updated as of an immediately preceding reverse diffusion step as the current continuous representation of the output sequence at the reverse diffusion step.

14. The method of claim 1, wherein the diffusion model is an attention-based neural network that includes one or more attention neural network layers.

15. The method of claim 1, further comprising, after performing the multiple reverse diffusion steps:
processing a final diffusion model input that comprises the current continuous representation that has been updated as of a last reverse diffusion step in the multiple reverse diffusion steps using the diffusion model to generate a final diffusion model output, wherein the final diffusion model output comprises, for each of the plurality of output positions, a respective final initial score for each of the plurality of embeddings in the vocabulary of embeddings;
selecting, for each of the plurality of output positions, an embedding from the vocabulary of embeddings using the respective final initial scores; and
generating the output sequence that includes discrete tokens corresponding to the selected embeddings.

16. The method of claim 1, further comprising, after performing the multiple reverse diffusion steps:
selecting, for each of the plurality of output positions, an embedding from the vocabulary of embeddings having a nearest distance to an embedding in the current continuous representation at the output position that has been updated as of the last reverse diffusion step in the multiple reverse diffusion steps; and
generating the output sequence that includes discrete tokens corresponding to the selected embeddings.

17. The method of claim 1, wherein the diffusion model is trained by optimizing a cross-entropy loss between the probability distribution over the plurality of embeddings in the vocabulary of embeddings that has been generated using the diffusion model output and a ground truth probability distribution over the plurality of embeddings in the vocabulary of embeddings.

18. The method of claim 17, wherein the embeddings in the vocabulary of embeddings are learned jointly with a training of the diffusion model by backpropagating gradients of the cross entropy loss computed with respect to parameters of the diffusion model into the embeddings.

19. The method of claim 1, wherein the discrete tokens comprise text characters, symbols, or signals.

20. The method of claim 1, wherein the diffusion model is configured to perform one or more of: a language modelling task comprising a prompt completion and/or infilling task, or a machine translation task, a speech transcription task, a video transcription task, an image captioning task, or an agent control task.

21. A system comprising one or more computers and one or more storage devices storing instructions that are operable, when executed by the one or more computers, to cause the one or more computers to perform operations for generating an output sequence that comprises a respective discrete token selected from a vocabulary of discrete tokens at each of a plurality of output positions, wherein the operations comprise:
initializing a continuous representation of the output sequence by assigning a respective embedding to each of one or more of the plurality of output positions, each embedding being selected from a vocabulary of embeddings that comprises a respective embedding corresponding to each discrete token in the vocabulary of discrete tokens;
repeatedly performing the following at each of multiple reverse diffusion steps:
obtaining a current continuous representation of the output sequence;
processing a diffusion model input that comprises the current continuous representation using the diffusion model to generate a diffusion model output, wherein the diffusion model output comprises, for each of the plurality of output positions, a respective initial score for each of the plurality of embeddings in the vocabulary of embeddings;
processing the respective initial scores using a softmax function to generate, for each of the plurality of output positions, a probability distribution over the plurality of embeddings in the vocabulary of embeddings that includes a respective probability score for each embedding in the vocabulary of embeddings; and
updating the current continuous representation of the output sequence using the probability distributions and the vocabulary of embeddings.

22. A non-transitory computer storage medium encoded with instructions that, when executed by one or more computers, cause the one or more computers to perform operations for generating an output sequence that comprises a respective discrete token selected from a vocabulary of discrete tokens at each of a plurality of output positions, wherein the operations comprise:
initializing a continuous representation of the output sequence by assigning a respective embedding to each of one or more of the plurality of output positions, each embedding being selected from a vocabulary of embeddings that comprises a respective embedding corresponding to each discrete token in the vocabulary of discrete tokens;
repeatedly performing the following at each of multiple reverse diffusion steps:
obtaining a current continuous representation of the output sequence;
processing a diffusion model input that comprises the current continuous representation using the diffusion model to generate a diffusion model output, wherein the diffusion model output comprises, for each of the plurality of output positions, a respective initial score for each of the plurality of embeddings in the vocabulary of embeddings;
processing the respective initial scores using a softmax function to generate, for each of the plurality of output positions, a probability distribution over the plurality of embeddings in the vocabulary of embeddings that includes a respective probability score for each embedding in the vocabulary of embeddings; and
updating the current continuous representation of the output sequence using the probability distributions and the vocabulary of embeddings.
